(19) United States
(12) Patent Application Publication
(10) Pub. No.: US 2023/0140046 A1
(43) Pub. Date: May 4, 2023

(54) TENSION MEMBER TENSION MONITORING ARRANGEMENT, A TENSION MEMBER TENSION MONITORING METHOD AND AN ELEVATOR

(71) Applicant: Kone Corporation, Helsinki (FI)

(72) Inventors: Petteri VALJUS, Helsinki (FI); Tapani TALONEN, Helsinki (FI); Timo LAMMINMAKI, Helsinki (FI)

(73) Assignee: Kone Corporation, Helsinki (FI)

(21) Appl. No.: 18/148,041

(22) Filed: Dec. 29, 2022

Related U.S. Application Data
(63) Continuation of application No. PCT/FI2020/050480, filed on Jul. 3, 2020.

(51) Int. Cl. B66B 7/12; B66B 5/00

(52) U.S. Cl. CPC B66B 7/1223; B66B 5/0006

(57) ABSTRACT

A tension member tension monitoring arrangement and method for measuring tension member tension of elevator tension members of a bundle of tension members, the elevator comprising an elevator car suspended by the tension members, such as ropes or belts, of the bundle of tension members, a termination at one end of a tension member and a mounting plate for attaching the termination relative to the hoistway, counterweight and/or the elevator. The tension member tension monitoring arrangement comprises at least one capacitive pressure sensor arranged in connection with a tension member termination. The arrangement further comprises a control unit connected to the at least one sensor. The at least one sensor is configured to sense the tension member forces of the tension members of the bundle of tension members attached to the tension member termination and generate a signal relating to one or more tension members of the tension member bundle readable and/or measurable by the control unit and proportional to the sensed load or force.

### CROSS-REFERENCE TO RELATED APPLICATION

This application is a continuation of PCT International Application No. PCT/FI2020/050480 which has an International filing date of Jul. 3, 2020, the entire contents of which are incorporated herein by reference.

### TECHNICAL FIELD

The invention relates to a tension member tension monitoring arrangement, a tension member tension monitoring method and an elevator.

### BACKGROUND

Elevator condition monitoring is used to ensure reliable operation and long life of an elevator and its components. Condition monitoring also enables other benefits such as cost savings, component lifetime prediction and large-scale data collection. As a part of the condition monitoring for elevators also tension member tension of the elevator tension members are monitored. This way for example long lifetime of traction sheave and suspension ropes can be achieved.

Tension member tension differences during elevator operation can be related e.g. to following matters: stiffness changes between the tension members during bending life, tolerance errors (e.g. too large tolerances) between traction sheave bending diameter, diameter variance between ropes in the same installation and tension member termination springs adjusted in an incorrect manner.

Early detection of tension differences and corrective actions in maintenance can prevent wear of traction sheave grooves. When tension member tensions start to vary, slip and surface pressure between each tension member and traction sheave grooves triggers groove wear. Even groove wear is not a big issue but uneven wear spoils the traction sheave. For example, if ropes are poorly lubricated the speed of groove wear is 4-6 times faster than in case where ropes are properly lubricated. Fast detection of the wear through ascending tension variation enables right timing for corrective actions which saves costs in maintenance.

Currently there are some rope tension measurement solutions available which utilize e.g. donut type-sensors where a termination rod goes through the sensor or rope bending-based sensors which have three legs engaged to each suspension rope. Problem with these prior art solutions is that they have high material and installation costs because they have to be customized for every elevator and the service or installation personnel have to install individual sensor elements one by one. Beside of material cost, typical problem is how to get sensor elements fit to the hitch plate design. Typically ropes and belts are placed very close to each other because bundle of ropes shall be tight to avoid fleet angles on nearest diverter pulleys and termination springs fit into tighter space than donut sensors do. Belts may also be located very close to each other and they do not let space for donut-type sensors.

Because of the problems discussed above, current sensor solutions are not widely used. Therefore, in practice uneven tension member tensions are currently monitored manually by the service personnel by looking at termination spring movements. In all cases spring movements do not clearly tell accurately the tension member tensions and tolerance area of springs is rather wide. Because of this good accuracy can't be achieved. Also, in some elevator types there is no access to car top when the elevator is running normally and this makes manual inspection of termination spring movement difficult or impossible.

For these reasons there is a need for improved solutions for a reliable and compact tension member tension monitoring for elevators and equipment related to elevator environment.

### SUMMARY

An object of the invention is to present a reliable and compact tension member tension monitoring solution for elevators which can be implemented in a cost-efficient way and installed easily by the service or installation personnel. The tension member comprises at least one rope and/or belt and bundle of tension members comprises a bundle of ropes and/or a bundle of belts.

According to a first aspect, the invention relates to a tension member tension monitoring arrangement for measuring tension member tension of individual elevator tension members of a bundle of tension members, the elevator comprising an elevator car suspended by the tension members of the bundle of tension members, a termination at one end of a tension member and a mounting plate for attaching the termination relative to the hoistway and/or the elevator. The tension member tension monitoring arrangement comprises at least one capacitive pressure sensor arranged in connection with a tension member termination and a control unit connected to the at least one sensor. The at least one sensor is configured to sense the tension member forces of the individual tension members of the bundle of tension members attached to the tension member termination and generate a signal relating to one or more tension members of the tension member bundle readable and/or measurable by the control unit and proportional to the sensed load or force.

In one embodiment of the invention the at least one capacitive pressure sensor is arranged beneath or above of individual tension member terminations, e.g. to car side tension member termination and/or hoistway tension member termination.

In one embodiment of the invention the arrangement comprises at least one washer arranged between the individual sensor element and a termination spring of a tension member, wherein the reaction force to the sensor element is guided through a washer.

In one embodiment of the invention the sensor comprises elastic material and capacitive sensing element arranged to the first side, e.g. below, the elastic material, and conductive plate arranged on the second side, e.g. on top, of the elastic material, wherein distance between the plate and capacitive element is configured to vary as a function of the load. The elastic material may comprise foam, solid plastic material, polyurethane, silicone, thermoplastic elastomer and/or BASF Cellasto, e.g. MH24-55.

In one embodiment of the invention an individual sensor and/or capacitive sensing element of the sensor has a round, a square or a honey-comb shape.

In one embodiment of the invention the arrangement comprises one sensor structure comprising multiple capacitive pressure sensor elements in the sensor structure wherein each sensor element is arranged in connection with an individual tension member termination.

In one embodiment of the invention the sensor structure comprises one conductive plate arranged on the second side, e.g. below, of the elastic material and multiple capacitive sensing elements arranged to the first side of the elastic material, e.g. on top, of the elastic material, each capacitive sensing element arranged in connection with an individual tension member termination.

In one embodiment of the invention the arrangement comprises conducting means and a connector for connecting the sensor to the control unit, wherein the conducting means are arranged between individual sensor elements and the connector.

In one embodiment of the invention the arrangement is configured to measure relative force values between the different tension members and/or tension member terminations and/or compare reaction forces between each tension member and/or tension member termination.

In one embodiment of the invention the arrangement is configured to measure reference level in the beginning of elevator operation life or force values without load, e.g. when tension members are loose, for example on car side.

In one embodiment of the invention the sensors are installed in connection with the elevator car side tension member termination and/or the arrangement is configured to operate as a weighting device by using sum of measured absolute loads for all tension members in determining weight of the elevator car and/or the load of the elevator car.

According to a second aspect, the invention relates to a method for measuring tension member tension of individual elevator tension members of a bundle of tension members with an tension member tension monitoring arrangement for elevators, the elevator comprising an elevator car suspended by the tension members of the bundle of tension members, a termination at one end of a tension member and a mounting plate for attaching the termination relative to the hoistway and/or the elevator. The tension member tension monitoring arrangement comprises at least one capacitive pressure sensor arranged in connection with a tension member termination and a control unit connected to the at least one sensor. In the method the at least one sensor senses the tension member forces of the tension member attached to the tension member termination and generates a signal readable and/or measurable by the control unit and proportional to the sensed load or force.

According to a third aspect, the invention relates to an elevator comprising an elevator car, an elevator motor configured to move the elevator car, and a tension member monitoring arrangement according to the solution of the invention.

According to a fourth aspect, the invention relates to computer program comprising instructions which, when executed by a computer, cause the computer to carry out the method according to invention.

According to a fifth aspect, the invention relates to computer-readable medium comprising the computer program according to invention.

With the solution of the invention, several benefits over the prior art solutions can be achieved. In one embodiment of the invention tension differences can be detected before they cause problem with traction sheave wear. It is also possible to carry out unmanned maintenance checks, which e.g. can give information when threshold value is exceeded and based on that it is possible for example to create a service call. It is also able to achieve an easy to use maintenance tool for adjusting tension member tensions and an installation check tool against any tight spots in shaft.

As the structure of the tension member tension monitoring solution is compact and comprises sensing elements for individual tension members it is easy to fit in the correct place and to connect to the control unit by the service or installation personnel.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

The embodiments of the invention are illustrated by way of example, and not by way of limitation, in the figures of the accompanying drawings, in which:

FIG. 1 presents an elevator according to one embodiment of the invention,

FIG. 2 presents an elevator according to one embodiment of the invention,

FIG. 3 presents an elevator according to one embodiment of the invention,

FIG. 4 presents one example embodiment of the tension member monitoring arrangement arranged in connection with tension member terminations, and

FIG. 5A presents one example embodiment of the sensor of the tension member tension monitoring arrangement,

FIG. 5B presents the example embodiment of the sensor of FIG. 5A as a cutaway drawing,

FIG. 6A presents one example of the sensor of the tension member monitoring arrangement,

FIG. 6B presents one example of the sensor of the tension member monitoring arrangement,

FIG. 6C presents one example of the sensor of the tension member monitoring arrangement,

FIG. 7 presents one example embodiment of the tension member tension monitoring arrangement.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

Reference will now be made in detail to the embodiments of the present invention, examples of which are illustrated in the accompanying drawings.

The solution of the invention relates to a tension member tension monitoring arrangement for measuring tension member tension of individual elevator tension members of a bundle of tension members. The tension member tension monitoring arrangement comprises at least one capacitive pressure sensor arranged in connection with a tension member termination and a control unit connected to the at least one sensor. The at least one sensor is configured to sense the tension member forces of the individual tension members of the bundle of tension members attached to the tension member termination and generate a signal relating to one or more tension members of the tension member bundle, the signal readable and/or measurable by the control unit and proportional to the sensed load or force. The tension member comprises at least one rope and/or belt and bundle of tension members comprises a bundle of ropes and/or a bundle of belts.

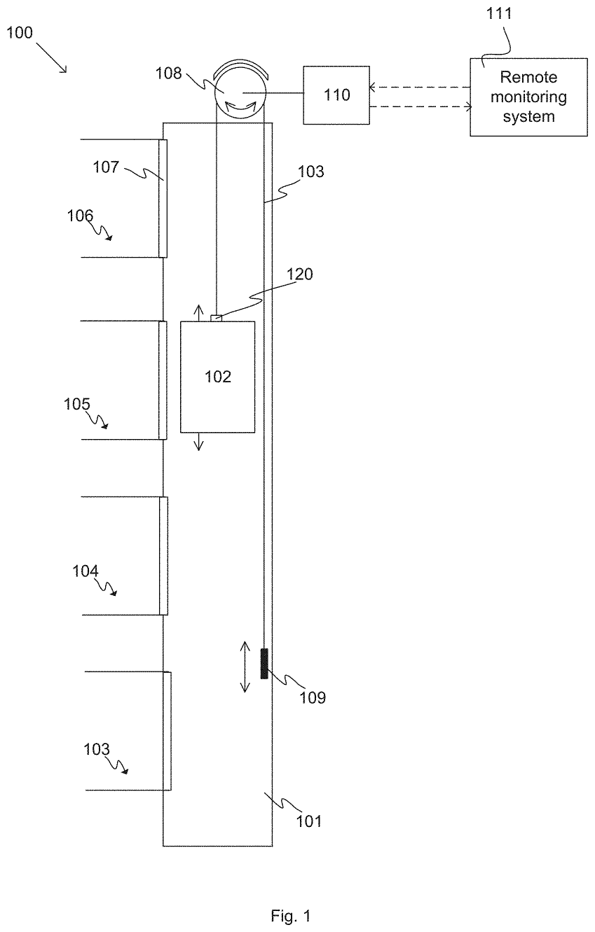

FIG. 1 illustrates an elevator system 100 according to one example embodiment of the invention where the solution of the invention can be used. The elevator system in this example embodiment comprises an elevator shaft 101 in which an elevator car 102 moves to serve different floors. In FIG. 1 only one type of elevator system is illustrated and described but the solution of the invention can be used for different kinds of elevators than what is described relating to FIG. 1. Although FIG. 1 illustrates four floors 103, 104, 105, 106, there may be any number of floors. Similarly, although FIG. 1 illustrates only one elevator shaft 101, there may be more than one elevator shaft in the elevator system. In the elevator system 100 illustrated in FIG. 1, there is one side towards which landing doors 107 at each floor can be opened. Although FIG. 1 illustrates one side, in another embodiment it is possible that the elevator car has doors towards more than one side of the elevator car 102.

The elevator car 102 is configured to perform a travel in the elevator shaft 101, wherein the elevator car is moved in this example by a motor via a traction sheave 108 and bundle of tension members 103, such as a bundle of ropes and/or bundle of belts. The term “travel” may refer to a process where the elevator car 102 may be configured to move in the elevator shaft 101 so that each floor is passed or visited at least once, i.e. the elevator car 102 can perform an end-to-end travel. In another embodiment, the travel in the elevator shaft 101 may not be a complete end-to-end travel. For example, it may not be possible to travel to one or more of the floors, for example, to the uppermost or the lowermost floor. The elevator system can comprise a controller 110 configured to control the movement of the elevator, and e.g. the motor and e.g. to communicate with a remote computer, such as a remote monitoring system 111, to which the tension member tension measurement results can be sent. The sensor 120 of the tension member tension monitoring arrangement can be arranged for example at the elevator car side and in this example the tension member monitoring sensor structure 120 is arranged in connection with the tension member terminations at the elevator car 102.

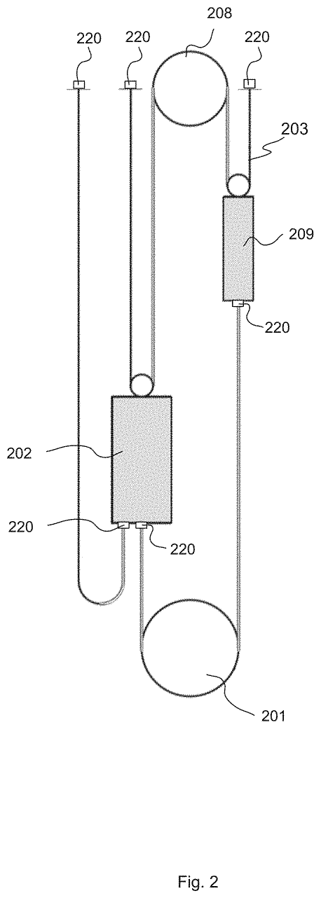

FIG. 2 presents another example of an elevator in which the solution of the invention can be used. In this example embodiment the elevator is a high-rise elevator. The example implementation comprises an elevator car 202, a tension member 203, such as a rope and/or a belt, a compensator 201, a traction sheave 208, and a counterweight 205. The sensor 220 of the tension member tension monitoring arrangement can be arranged in this example embodiment in connection with one tension member termination, multiple tension member termination locations or all tension member termination locations, e.g. in connection with the elevator tension member terminations, the counterweight tension member terminations and/or the hoistway tension member terminations.

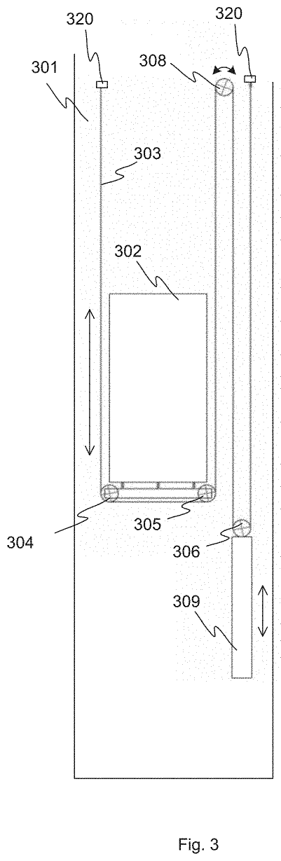

FIG. 3 presents another example of an elevator in which the solution of the invention can be used. In this example embodiment the elevator is a two to one (2:1) roping-ratio type elevator. Also, this type of elevator is arranged to move in the elevator shaft 301 and comprises a counterweight 309. In this type of an elevator tension members 303, such as ropes and/or belts, are arranged such that one end of each tension member passes from a dead end hitch in the overhead, down and under a car sheaves 304, 305, up over the hoist machine traction sheave 308, down around a counterweight sheave 306, and up to another dead end hitch in the overhead The sensor 320 of the tension member tension monitoring arrangement can be arranged in this example embodiment in connection with one tension member termination or multiple tension member termination locations, e.g. in connection with the hoistway tension member terminations.

In the solution of the invention the at least one capacitive pressure sensor 420 can be arranged beneath or above of individual tension member terminations, such as a rope terminations and/or a belt terminations, for example to car side tension member termination and/or hoistway tension member termination.

In one embodiment of the invention, the arrangement comprises at least one washer arranged between the individual sensor element and a termination spring of a tension member. In this case reaction force to the sensor element can be guided through suitable washer which is between sensor and termination spring. This way the load bearing area can be maximized. The sizes of the rings and geometry of the sensor structure can be optimized and selected based on e.g. elevator type, tension member thickness, number of tension members in the bundle of tension members, etc.

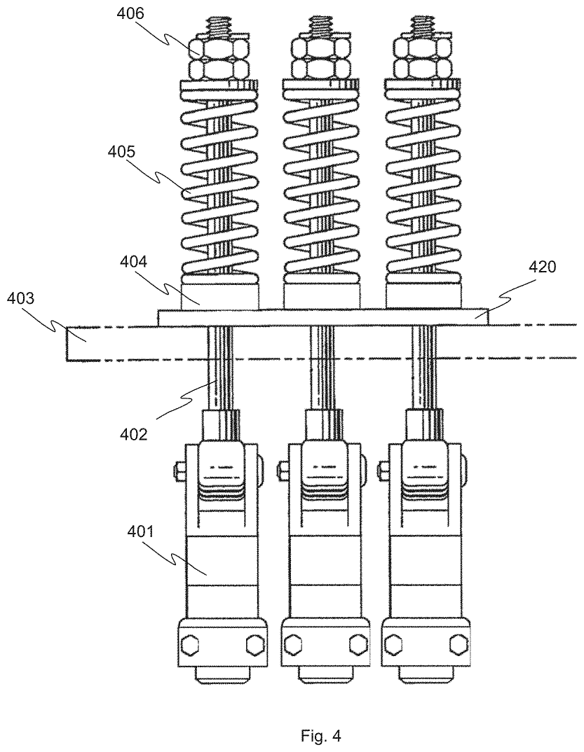

FIG. 4 presents one example embodiment of the tension member monitoring arrangement arranged in connection with tension member terminations. The example arrangement comprises a termination 401 at one end of the tension member, a mounting plate 403 for attaching the termination relative to the hoistway or the elevator car. The sensor structure 420 is positioned between the hitch 402 and the mounting plate 403 so that a signal is generated by the sensor 420 proportional to the load of the individual tension member terminations 401. A washer 404 can be arranged fitted between the sensor 420 and the spring 405 to evenly distribute the load over an individual sensor element.

The terminations may include a rod 402 having a threaded end. The rod may extend through a mounting plate 403 for attachment to a hitch. The mounting plate 403 may be fixed to a guiderail, machine beam, the wall of the hoistway, or the elevator car. In the alternative the mounting plate may be eliminated, and the terminations attached directly to the machine beam or other suitable structure. A spring 405 or buffer can be arranged over the rod 402. The spring 405 can held in place between the upper surface of the mounting plate 403 and a washer 404 for example by a first nut and a lock nut.

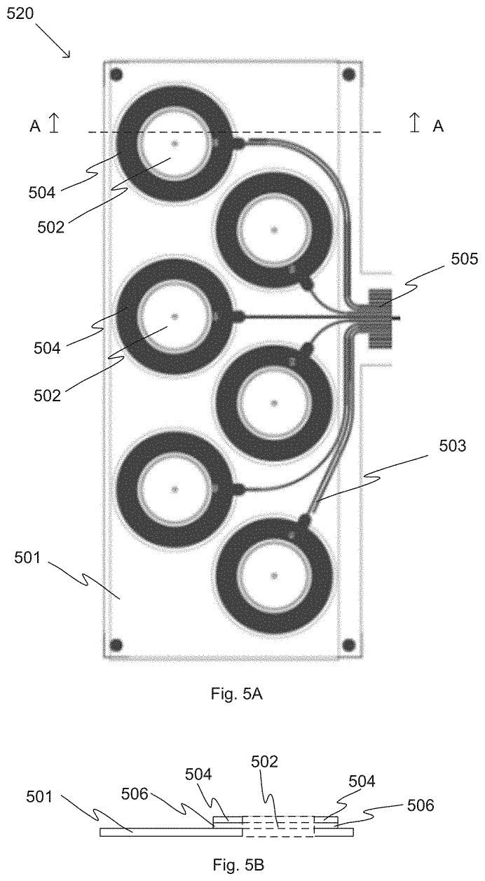

FIG. 5A presents one example embodiment of the one sensor 520 of the tension member tension monitoring arrangement. The sensor 520 comprises multiple capacitive pressure sensors elements. Each sensor element is arranged in connection with an individual tension member termination and configured to sense forces of an individual tension member. The sensor elements have a hole 502 in the middle of the sensor element where the tension member can be guided through. The sensor structure and the pressure sensors can have an essentially flat shape. The sensor elements can be arranged to the sensor structure side by side and one after another and/or e.g. in a staggered pattern. The structure can be arranged e.g. on a circuit board. The sensor structure comprises one conductive plate 501 which in this example covers essentially the area of the sensor structure apart the holes arranged to the sensor structure.

The arrangement can comprise conducting means 503 and a connector 505 for connecting the sensor to the control unit, e.g. elevator control unit or sensor control unit. The conducting means 503 are arranged between individual sensor elements and the connector 505.

The sensor structure can comprise one conductive plate arranged on the second side, e.g. below, of the elastic material and multiple capacitive sensing elements arranged to the first side of the elastic material, e.g. on top, of the elastic material, each capacitive sensing element arranged in connection with an individual tension member termination. In one embodiment of the invention the distance between the conducting plate and capacitive element is configured to vary as a function of the load because of elastic material arranged between the capacitive sensing elements and the conducting plate. The elastic material can comprise e.g. foam, solid plastic material, polyurethane, silicone, thermoplastic elastomer or BASF Cellasto, e.g. MH24-55.

FIG. 5B presents the example embodiment of the sensor of FIG. 5A as a cutaway drawing viewed from the line A-A of FIG. 5A. In this embodiment the conducting plate 501 is arranged on the bottom of the sensor structure. A circuit board can be arranged under the conductive plate 501. The elastic material 506 is arranged on top of the conductive plate 501 and around the hole 502. A capacitive sensing element 504 is arranged on top of the elastic material 506 and around the hole 502. Thus, the elastic material is arranged between the conductive plate 501 and a capacitive sensing element 504 so that the distance between the conducting plate and capacitive element is configured to vary as a function of the load.

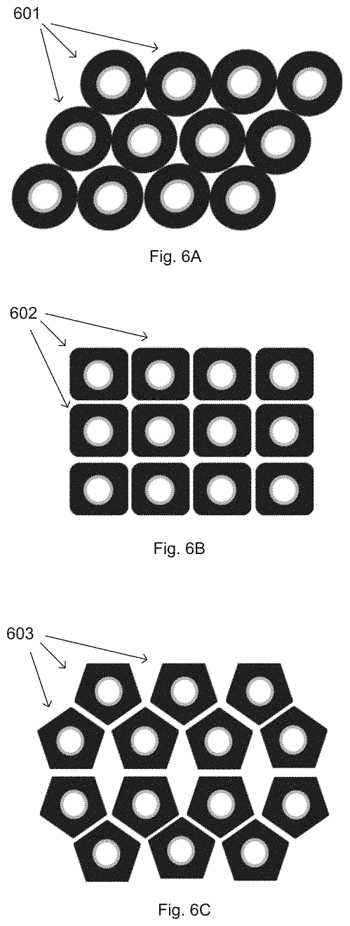

FIGS. 6A-C present examples of the sensor of the tension member monitoring arrangement. In these examples the individual sensor elements and their arrangement in relation to the other sensor elements is illustrated. In the example of FIG. 6A the individual sensing elements 601 have a round shape. In the example of FIG. 6B the individual sensing elements 602 have a square shape. In the example of FIG. 6C the individual sensing elements 603 have a honey-comb shape. The individual sensing elements are arranged to the sensor structure side by side and one after another so that the structure is compact and thus it is easier to be installed to the required location.

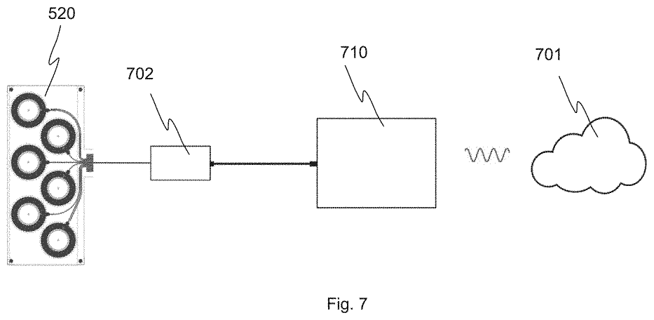

FIG. 7 presents one example embodiment of the tension member tension monitoring arrangement. This example presents how the monitoring results can be created, collected and utilized. The monitoring system comprises a control unit 702 which is connected to the sensor 520. The control unit 702 can control the measurements based on the received signals from the individual elements and/or the sensor 520. The sensor control unit 702 can be connected to the elevator control unit 710. In one embodiment of the invention the sensor control unit 702 can be integrated to the sensor 520. In one embodiment of the invention the sensor control unit 702 can be integrated to the elevator control unit 710. The sensor control unit 702 or elevator control unit 710 (as illustrated in the FIG. 7) can be configured to send the monitoring results to an external computer 701, such as an external server and/or an external service, e.g. a cloud service.

In one embodiment of the invention the arrangement, e.g. by a control unit controlling the measurement event, is configured to measure relative force values between the different tension members and/or tension member terminations and/or compare reaction forces between each tension member and/or tension member termination. In one example the arrangement is configured to measure reference level in the beginning of elevator operation life or force values without load, e.g. when tension members are loose, for example on car side.

In one embodiment of the invention the sensors are installed in connection with the elevator car side tension member termination and/or the arrangement is configured to operate as a weighting device by using sum of measured absolute loads for all tension members in determining weight of the elevator car and/or the load of the elevator car.

The tension member tension monitoring arrangement and/or a remote computer connected to the tension member tension monitoring arrangement may present the tension member tension measurement results to the user devices and/or elevator monitoring devices and, e.g. create alarms if the tension member tensions of the elevators are not optimal or within the accepted range of values. This way for example the tension member forces can be easily monitored and adjusted by the service personnel and deviations from the allowed values can be quickly informed to the service personnel. The solution of the invention can also be used as a tool to find tight spots on shaft during elevator ride. In this case the measurements have to be done with relatively often so that different tight spots at different positions in the shaft can be measured reliably.

A controller of an elevator system or the sensor which can be used in one embodiment of the invention may comprise at least one processor connected to at least one memory. The at least one memory may comprise at least one computer program which, when executed by the processor or processors, causes the controller to perform the programmed functionality. In another embodiment, the at least one memory may be an internal memory of the at least one processor. The controller may also comprise an input/output interface. Via the input/output interface, the control apparatus may be connected to at least one wireless device. The controller may be a control entity configured to implement only the above disclosed operating features, or it may be part of a larger elevator control entity, for example, an elevator controller or an elevator group controller.

As stated above, the components or other parts of the exemplary embodiments can include computer readable medium or memories for holding instructions programmed according to the teachings of the present embodiments and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD1RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge or any other suitable medium from which a computer can read.

The embodiments of the invention described hereinbefore in association with the figures presented and the summary of the invention may be used in any combination with each other. At least two of the embodiments may be combined together to form a further embodiment of the invention.

The specific examples provided in the description given above should not be construed as limiting the applicability and/or the interpretation of the appended claims. Lists and groups of examples provided in the description given above are not exhaustive unless otherwise explicitly stated.

1. A tension member tension monitoring arrangement for measuring tension member tension of elevator tension members of a bundle of tension members, the elevator comprising an elevator car suspended by the tension members, such as ropes or belts, of the bundle of tension members, a termination at one end of a tension member and a mounting plate for attaching the termination relative to the hoistway, counterweight, and/or the elevator car,
wherein the tension member tension monitoring arrangement comprises at least one capacitive pressure sensor arranged in connection with a tension member termination,
wherein the arrangement further comprises a control unit connected to the at least one sensor,
wherein the at least one sensor is configured to sense the tension member forces of the tension members of the bundle of tension members attached to the tension member termination and generate a signal relating to one or more tension members of the tension member bundle readable and/or measurable by the control unit and proportional to the sensed load or force.

2. An arrangement according to claim 1, wherein the at least one capacitive pressure sensor is arranged beneath or above of individual tension member terminations, e.g. to car side tension member termination, counterweight side tension member termination and/or hoistway tension member termination.

3. An arrangement according to claim 1, wherein the arrangement comprises at least one washer arranged between the individual sensor element and a termination spring of a tension member, wherein the reaction force to the sensor element is guided through a washer.

4. An arrangement according to claim 1, wherein the sensor comprises elastic material and capacitive sensing element arranged to the first side, e.g. on top, of the elastic material, and conductive plate arranged on the second side, e.g. under, of the elastic material, wherein distance between the conductive plate and the capacitive element is configured to vary as a function of the load, and/or wherein the elastic material comprises foam, solid plastic material, polyurethane, silicone, thermoplastic elastomer and/or BASF Cellasto, e.g. MH24-55.

5. An arrangement according to claim 1, wherein an individual sensor element and/or capacitive sensing element of the sensor has a round, a square or a honey-comb shape.

6. An arrangement according to claim 1, wherein the arrangement comprises one sensor structure comprising multiple capacitive pressure sensor elements in the sensor structure wherein each sensor element is arranged in connection with an individual tension member termination.

7. An arrangement according to claim 6, wherein the sensor structure comprises one conductive plate arranged on the second side, e.g. below, of the elastic material and multiple capacitive sensing elements arranged to the first side of the elastic material, e.g. on top of the elastic material, each capacitive sensing element arranged in connection with an individual tension member termination.

8. An arrangement according to claim 1, wherein the arrangement comprises conducting means and a connector for connecting the sensor to the control unit, wherein the conducting means are arranged between individual sensor elements and the connector.

9. An arrangement according to claim 1, wherein the arrangement is configured to measure relative force values between the different tension members and/or tension member terminations and/or compare reaction forces between each tension member and/or tension member termination.

10. An arrangement according to claim 1, wherein the arrangement is configured to measure reference level in the beginning of elevator operation life or force values without load, e.g. when tension members are loose, for example on car side.

11. An arrangement according to claim 1, wherein the at least one sensor is installed in connection with the elevator car side tension member termination and/or the arrangement is configured to operate as a weighting device by using sum of measured absolute loads for all tension members in determining weight of the elevator car and/or the load of the elevator car.

12. A method for measuring tension member tension of elevator tension members of a bundle of tension members with an tension member tension monitoring arrangement for elevators, the elevator comprising an elevator car suspended by the tension members, such as ropes or belts, of the bundle of tension members, a termination at one end of a tension member and a mounting plate for attaching the termination relative to the hoistway, counterweight and/or the elevator car,
wherein the tension member tension monitoring arrangement comprises at least one capacitive pressure sensor arranged in connection with a tension member termination,
wherein the arrangement further comprises a control unit connected to the at least one sensor,
wherein in the method the at least one sensor senses the tension member forces of the tension member attached to the tension member termination and generates a signal readable and/or measurable by the control unit and proportional to the sensed load or force.

13. A method according to claim 12, wherein the arrangement measures relative force values between the different terminations and/or compares reaction forces between each termination.

14. A method according to claim 12, wherein the arrangement measures reference level in the beginning of elevator operation life or force values without load, e.g. when tension members are loose, for example on car side.

15. A method according to claim 12, wherein the at least one sensor is installed in connection with the elevator car side tension member termination and/or the arrangement is configured to operate as a weighting device by using sum of measured absolute loads for all tension members in determining weight of the elevator car and/or the load of the elevator car.

16. An elevator comprising
an elevator car,
an elevator motor configured to move the elevator car, and
a tension member tension monitoring arrangement according to claim 1.

17. A computer program comprising instructions which, when executed by a computer, cause the computer to carry out the method according to claim 12.

18. A computer-readable medium comprising the computer program according to claim 17.
